(19) United States
(12) Patent Application Publication
(10) Pub. No.: US 2024/0067553 A1
(43) Pub. Date: Feb. 29, 2024

(54) METHOD AND SYSTEM FOR IMPROVING SOLID-LIQUID SEPARATION PERFORMANCE OF SLUDGE BY IN-SITU CRYSTALLIZATION OF WATER

(71) Applicant: Tongji University, Shanghai (CN)

(72) Inventors: Boran Wu, Shanghai (CN); Xiaohu Dai, Shanghai (CN)

(73) Assignee: Tongji University, Shanghai (CN)

(21) Appl. No.: 18/159,302

(22) Filed: Jan. 25, 2023

(30) Foreign Application Priority Data
Aug. 31, 2022 (CN) 202211051528.2

(51) Int. Cl. C02F 11/143

(52) U.S. Cl. CPC C02F 11/143; C02F 2209/02; C02F 2209/03

(57) ABSTRACT

The present disclosure relates to a method and system for improving solid-liquid separation performance of sludge by in-situ crystallization of water. The method comprises the following steps: adding sludge into a pressure vessel, intermittently introducing high-pressure carbon dioxide at a low-temperature condition to generate a carbon dioxide hydrate until a partial pressure of the carbon dioxide is stable, releasing the pressure, and stirring the sludge until no gas escapes, thus obtaining the treated sludge. Compared with the prior art, the method and system provided by the present disclosure are simple and easy to implement, has no consumption of sludge dewatering conditioning agents, and can achieve the recycling of carbon dioxide. The secondary environmental pollution risk caused by the sludge dewatering conditioning agent is reduced, the shortcomings of high dosage of chemicals, large sludge enlargement ratio, low sludge dewatering efficiency and the like in the traditional sludge dewatering process can be overcome.

### TECHNICAL FIELD

The present disclosure belongs to the technical field of water treatment, and relates to a method and system for improving solid-liquid separation performance of sludge by in-situ crystallization of water.

### BACKGROUND

Sludge of urban sewage treatment plants (hereinafter referred to as sludge) refers to the sediment transformed by pollutants as well as microbial residues produced by biodegradation of pollutants during sewage treatment. The sludge carries 20˜25% of the total intake pollutants of the sewage pipe network, including a variety of pathogenic bacteria, heavy metals and toxic organic pollutants, which may cause serious environmental pollution risks if not properly disposed. Safe treatment and disposal as well as efficient resource utilization of the sludge are of a great significance to improve the technical level of water pollution control in China.

High-water-content characteristic is one of the main factors limiting the sludge treatment and disposal efficiency. A series of standards and specifications for sludge transportation, pyrolysis, incineration and land use in urban sewage treatment plants have made specific technical requirements for water content of the sludge, among which dewatering is a common key technical link in various sludge treatment and disposal routes. Especially, heat treatment (incineration, pyrolysis) has become one of the rapid development directions of final disposal of the sludge in China in recent years due to its remarkable benefits in reduction, stabilization and energy utilization. Therefore, it is also an important technical prerequisite for low-carbonization, centralized and large-scale treatment and disposal of sludge in China to reduce the moisture content of sludge as well as improve the caloric value of the sludge efficiently and with low consumption. However, sludge is a non-homogeneous complex system with a high degree of organic-inorganic mixing, presenting a stable colloidal floc state and extremely difficult solid-liquid separation, and thus dewatering conditioning measures are an important guarantee to improve dewatering performance of the sludge and effectively realize solid-liquid separation.

In the existing sludge dewatering conditioning technologies, the dewatering performance of sludge is mainly improved by changing aggregation states and physical and chemical properties of solid particles by means of coagulation/flocculation, advanced oxidation, thermal hydrolysis, etc., which generally have the problems of high drug consumption, high energy consumption, low efficiency, and difficulty in precise control, etc., resulting in sludge dewatering which has become the main technical bottleneck restricting the efficiency improvement of the whole chain process of sludge treatment and disposal. Especially, coagulants and flocculants represented by poly aluminum chloride, poly ferric chloride and polyacrylamide are the most widely used sludge dewatering conditioning agents, which can change the surface electricity and aggregation states of solid particles in the sludge through electrical neutralization and adsorption bridging actions, can reduce the interstitial water content of sludge to a certain extent and promote the removal of free water from sludge, but cannot deeply remove capillary water and surface attached water. In addition, the use of chlorine-containing coagulants aggravates the risk of dioxin formation in the sludge incineration process, while polyacrylamide may cause soil hardening and limit the land use of sludge. Therefore, it has broad market application prospects and social and environmental benefits to develop an efficient sludge dewatering conditioning technology capable of recycling a dewatering conditioning agent as well as strengthening deep removal and transformation of capillary water and interstitial water.

### SUMMARY

An objective of the present disclosure is to provide a method and system for improving solid-liquid separation performance of sludge by in-situ crystallization of water, which have the advantages of no consumption of conditioning agents, simple process flow and the like.

The objective of the present disclosure may be achieved through the following technical solutions:

A method for improving solid-liquid separation performance of sludge by in-situ crystallization of water comprises the following steps:
1) adding sludge into a pressure vessel and cooling the sludge;
2) introducing carbon dioxide gas into the cooled sludge, and enabling a partial pressure of the carbon dioxide to be higher than an equilibrium partial pressure of a carbon dioxide hydrate (CO₂·6H₂O) at a corresponding temperature;
3) continuing to stir to make the sludge react with the carbon dioxide at a constant temperature to generate a carbon dioxide hydrate, wherein the partial pressure of the carbon dioxide gradually drops to a phase equilibrium pressure with the process of generation of the carbon dioxide hydrate;
4) repeating the step 2) to step 3) until the water in the sludge is completely transformed into the carbon dioxide hydrate (the pressure of the carbon dioxide gas is unable to drop after the carbon dioxide gas is inflated into a reactor); and
5) releasing the gas pressure of the sealed reactor, starting to decompose the carbon dioxide hydrate, recovering released carbon dioxide gas for reuse, and discharging the treated sludge.

Further, in the step 1), the sludge is preferably residual sludge from a sewage treatment plant, and the sludge has a water content of 90% to 99%.

Further, in the step 1), the sludge is cooled to 1° C. to 10° C.

Further, in the step 2), the partial pressure of the introduced carbon dioxide is 1,500 kPa to 5,000 kPa.

Further, in the step 3), the phase equilibrium pressure of the carbon dioxide is 1,414 kPa to 4,292 kPa.

Further, in the step 4), the consumption of the carbon dioxide and the generation of the carbon dioxide hydrate are calculated through the drop of the partial pressure of the carbon dioxide and the volume of gas in the reactor, and then a transformation rate of water in sludge into the hydrate is determined.

Preferably, in the step 5), the system pressure drops to below the equilibrium pressure of the corresponding carbon dioxide hydrate, the carbon dioxide hydrate is decomposed step by step until no carbon dioxide escapes. The sludge is discharged from a valve at the lower end of the sealed reactor, and the discharge level should not be lower than a valve outlet, thus preventing damage to the water seal of the reactor as well as gas leakage.

A reaction system capable of achieving the method above comprises a reaction kettle body for accommodating sludge, a refrigeration jacket arranged outside the reaction kettle body, a gas compressor and a carbon dioxide storage tank which are in communication with the reaction kettle body in sequence, and a stirring assembly arranged on the reaction kettle body.

Further, the system comprises a cooler and a refrigerant circulating pipe which are in circular communication. The refrigeration jacket is internally provided a refrigerating medium, and the refrigerant circulating pipe is immersed in the refrigerating medium.

Further, the refrigeration jacket is also provided with a temperature detection sensor.

Further, the reaction kettle body is also provided with a carbon dioxide pressure sensor.

Further, the bottom of the reaction kettle body is also provided with a sludge discharge pipe.

Compared with the prior art, the present disclosure has the following features:

The treatment method provided by the present disclosure is simple and easy to implement, has no consumption of sludge dewatering conditioning agents, and can achieve the recycling of carbon dioxide. The secondary environmental pollution risk caused by the sludge dewatering conditioning agent is reduced, the shortcomings of high dosage of chemicals, large sludge enlargement ratio, low sludge dewatering efficiency and the like in the traditional sludge dewatering process can be overcome, and the material consumption and process operation cost for sludge dewatering conditioning are reduced. Therefore, the treatment method and system have excellent economic benefits, social environmental benefits and broad market application prospects.

### BRIEF DESCRIPTION OF THE DRAWINGS

FIG. 1 is a structure diagram of a reaction system in accordance with the present disclosure.

In the drawings:

1—Carbon dioxide pressure sensor; 2—temperature detection sensor; 3—refrigeration jacket; 4—refrigerant circulating pipe; 5—cooler; 6—sludge discharge pipe; 7—carbon dioxide storage tank; 8—gas compressor; 9—carbon dioxide injection pipe; 10—stirring paddle; 11—stirrer; 12—sludge.

### DETAILED DESCRIPTION OF THE EMBODIMENTS

The present disclosure is described in detail below with reference to the accompanying drawings and specific embodiments.

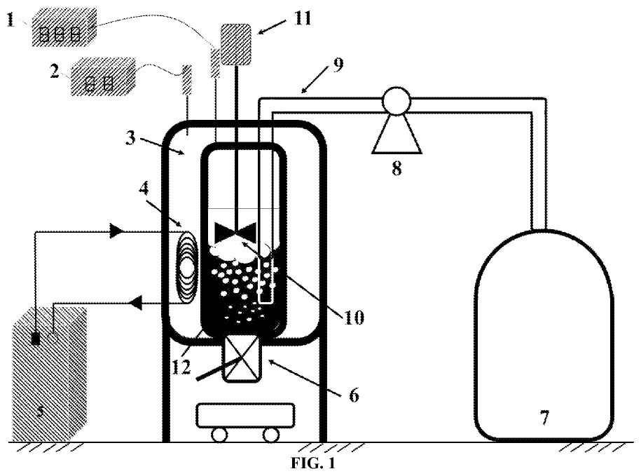

A reaction system as shown in FIG. 1 comprises a reaction kettle body for accommodating sludge 12; a refrigeration jacket 3 arranged outside the reaction kettle body and provided with a refrigerating medium; a refrigerant circulating pipe 4 immersed in the refrigerating medium; a cooler 5 in circular communication with the refrigerant circulating pipe 4; a temperature detection sensor 2 arranged on the refrigeration jacket 3; a gas compressor 8 and a carbon dioxide storage tank 7 which are in communication with the reaction kettle body in sequence by means of a carbon dioxide injection pipe 9; a carbon dioxide pressure sensor 1 arranged on the reaction kettle body 1; a sludge discharge pipe 6 arranged at the bottom of the reaction kettle body; and a stirring assembly arranged on the reaction kettle body. The stirring assembly comprises a stirrer 11 and a stirring paddle 10.

A method for improving solid-liquid separation performance of sludge by in-situ crystallization of water based on the reaction system above comprises the following steps:
S1: adding sludge into the reaction kettle body, and cooling the reaction kettle body to 1° C. to 10° C. by the cooler 5, the refrigerant circulating pipe 4 as well as cooling water in the refrigeration jacket 3, and holding the temperature;
S2: continuing to introduce carbon dioxide into the reaction kettle body to make a partial pressure of the carbon dioxide reach 1,500 kPa to 5,000 kPa;
S3: holding a low-temperature condition, and continuing to stir, where the partial pressure of the carbon dioxide gradually drops to a phase equilibrium pressure 1,414 kPa to 4,292 kPa as the carbon dioxide reacts with the sludge to generate a carbon dioxide hydrate;
S4: repeating the step S2 to step S3 until the partial pressure of the carbon dioxide is stable and no longer drops after the carbon dioxide introduction is stopped, where all the water in the sludge is transformed into the carbon dioxide hydrate at the moment by reacting with the carbon dioxide;
S5: slowly releasing the pressure of the carbon dioxide by a pressure-relief valve or a gas discharge pipe, and continuing to stir to make the carbon dioxide hydrate be gradually re-decomposed into the carbon dioxide gas and water until no carbon dioxide gas escapes; and recycling the discharged carbon dioxide; and
S6: discharging the treated sludge from a sludge discharge pipe 6 to obtain the sludge with improved dewatering performance.

According to the present disclosure, by continuously introducing the carbon dioxide into the sludge at the conditions of low temperature and high pressure, all the water in the sludge reacts is transformed into the carbon dioxide hydrate by reacting with the carbon dioxide. Then, by slowly dropping the partial pressure of the carbon dioxide, the carbon dioxide hydrate is gradually re-decomposed into the carbon dioxide gas and the water, and the sludge with improved dewatering performance is obtained.

Through the above synthesis process of the carbon dioxide hydrate, the spatial arrangement and conformation of organic matters and water molecules in the sludge are optimized, and interstitial water in the sludge is transferred into continuous and uniform hydrate crystals, thus reducing the interstitial water content, promoting the aggregation and precipitation of hydrophilic solid components, destroying the colloidal floc state of the sludge with stable and suspended distribution of hydrophilic solid components in water, and improving the solid-liquid separation performance of the sludge.

The embodiment is implemented on the premise of the technical solution of the present disclosure, and provides the detailed implementations and specific operation process, but the scope of protection of the present disclosure is not limited to the following embodiments.

The following embodiments all employ the reaction system above

### Embodiment 1

In accordance with the embodiment, a method for improving solid-liquid separation performance of sludge by in-situ crystallization of water comprises the following steps:
(1) injecting 100 mL of sludge (with water content of 98%) from a secondary sedimentation tank of a certain municipal sewage treatment plant in Changsha City of Hunan Province into a cylindrical high-pressure reactor (with the volume of 500 mL), introducing circulating cooling water into an external jacket of the high-pressure reactor to reduce the sludge temperature in the reactor to 1° C., and holding the temperature;
(2) connecting a carbon oxide steel cylinder to the high-pressure reactor, introducing carbon dioxide from the steel cylinder into the high-pressure reactor to make a partial pressure of the carbon dioxide reach 5,000 kPa;
(3) holding the reaction system temperature (1° C.) in the step (1) and step (2), continuing to stir, where the partial pressure of the carbon dioxide gradually drops to a phase equilibrium pressure 1,414 kPa as the carbon dioxide reacts with the sludge to generate a carbon dioxide hydrate;
(4) continuously repeating the step (2) and step (3) until the partial pressure of the carbon dioxide in the reactor no longer drops, where the water in the sludge is transformed into the carbon dioxide hydrate at the moment;
(5) releasing the gas pressure in the high-pressure reactor by a pressure-relief valve of the high-pressure reactor and a gas discharge pipe of the high-pressure reactor, continuing to stir to make the carbon dioxide hydrate be gradually decomposed until no carbon dioxide gas escapes; discharging the treated sludge from a valve at the lower part of the high-pressure reactor, and determining capillary water absorption time of the sludge to characterize the dewatering performance thereof. As shown in Table 1, it can be seen that the capillary water absorption time of the treated sludge decreases significantly and the dewatering performance improves significantly.

TABLE 1
Dewatering performance of sludge treated by
sludge dewatering conditioning technology
based on in-situ crystallization of water

| | Capillary water |
|---|---|
| | absorption time (s) |
| Original sludge | 69.8 s |
| Sludge treated by in-situ | 18.1 s |
| crystallization reaction | |

### Embodiment 2

In accordance with the embodiment, a method for improving solid-liquid separation performance of sludge by in-situ crystallization of water comprises the following steps:
(1) injecting 100 mL of sludge (with water content of 90%) from a certain municipal sewage treatment plant in Shanghai City into a cylindrical high-pressure reactor (with the volume of 500 mL), introducing circulating cooling water into an external jacket of the high-pressure reactor to reduce the sludge temperature in the reactor to 5° C. and holding the temperature;
(2) connecting a carbon oxide steel cylinder to the high-pressure reactor, introducing carbon dioxide from the steel cylinder into the high-pressure reactor to make a partial pressure of the carbon dioxide reach 4,000 kPa;
(3) holding the reaction system temperature (5° C.) in the step (1) and step (2), continuing to stir, where the partial pressure of the carbon dioxide gradually drops to a phase equilibrium pressure of 2,227 kPa as the carbon dioxide reacts with the sludge to generate a carbon dioxide hydrate;
(4) continuously repeating the step (2) and step (3) until the partial pressure of the carbon dioxide in the reactor is kept at 4,000 kPa and no longer drops after the carbon dioxide gas is inflated, where the water in the sludge is transformed into the carbon dioxide hydrate at the moment;
(5) releasing the gas pressure in the high-pressure reactor by a pressure-relief valve of the high-pressure reactor and a gas discharge pipe of the high-pressure reactor, continuing to stir to make the carbon dioxide hydrate be gradually decomposed until no carbon dioxide gas escapes; discharging the treated sludge from a valve at the lower part of the high-pressure reactor, and determining capillary water absorption time of the sludge to characterize the dewatering performance thereof. As shown in Table 2, it can be seen that the capillary water absorption time of the treated sludge decreases significantly and the dewatering performance improves significantly.

TABLE 2
Dewatering performance of sludge treated by
sludge dewatering conditioning technology
based on in-situ crystallization of water

| | Capillary water |
|---|---|
| | absorption time (s) |
| Original sludge | 1206.2 s |
| Sludge treated by in-situ | 261.4 s |
| crystallization reaction | |

### Embodiment 3

In accordance with the embodiment, a method for improving solid-liquid separation performance of sludge by in-situ crystallization of water comprises the following steps:
(1) injecting 100 mL of sludge (with water content of 95%) from a certain municipal sewage treatment plant in Shanghai City into a cylindrical high-pressure reactor (with the volume of 500 mL), introducing circulating cooling water into an external jacket of the high-pressure reactor to reduce the sludge temperature in the reactor to 10° C. and holding the temperature.
(2) connecting a carbon oxide steel cylinder to the high-pressure reactor, introducing carbon dioxide from the steel cylinder into the high-pressure reactor to make a partial pressure of the carbon dioxide reach 5,000 kPa;
(3) holding the reaction system temperature (10° C.) in the step (1) and step (2), continuing to stir, where the partial pressure of the carbon dioxide gradually drops to a phase equilibrium pressure of 4,292 kPa as the carbon dioxide reacts with the sludge to generate a carbon dioxide hydrate;
(4) continuously repeating the step (2) and step (3) until the partial pressure of the carbon dioxide in the reactor is kept at 5,000 kPa and no longer drops after the carbon dioxide gas is inflated, where the water in the sludge is transformed into the carbon dioxide hydrate at the moment;
(5) releasing the gas pressure in the high-pressure reactor by a pressure-relief valve of the high-pressure reactor and a gas discharge pipe of the high-pressure reactor, continuing to stir to make the carbon dioxide hydrate be gradually decomposed until no carbon dioxide gas escapes; discharging the treated sludge from a valve at the lower part of the high-pressure reactor, and determining capillary water absorption time of the sludge to characterize the dewatering performance thereof. As shown in Table 3, it can be seen that the capillary water absorption time of the treated sludge decreases significantly and the dewatering performance improves significantly.

TABLE 3
Dewatering performance of sludge treated by
sludge dewatering conditioning technology
based on in-situ crystallization of water

| | Capillary water |
|---|---|
| | absorption time (s) |
| Original sludge | 352.6 s |
| Sludge treated by in-situ | 86.3 s |
| crystallization reaction | |

In conclusion, it can be seen that in the embodiment 1, embodiment 2 and embodiment 3, different initial water contents of the sludge, different reaction temperatures in the high-pressure reactor and different phase equilibrium partial pressures of carbon dioxide hydrate corresponding to different reaction temperatures lead to different numbers of sequencing batch reaction required for all transformation of the water in the sludge, but the capillary water absorption time of the treated sludge decreases significantly and the dewatering performance of the treated sludge improves significantly.

The above description of the embodiments is for the convenience of those of ordinary skill in the art to understand and use the present disclosure. Apparently, those skilled in the art can easily make various modifications to these embodiments and apply the general principles described here to other embodiments without creative efforts. Therefore, the present disclosure is not limited to the embodiments above. The improvements and modifications made by those skilled in the art without departing from the scope of the present disclosure based on the disclosure of the present disclosure should be within the scope of protection of the present disclosure.

1. A method for improving solid-liquid separation performance of sludge by in-situ crystallization of water, comprising the following steps: adding sludge into a pressure vessel, intermittently introducing high-pressure carbon dioxide at a low-temperature condition until a partial pressure of the carbon dioxide is stable, releasing the pressure, and stirring the sludge until no gas escapes, thus obtaining treated sludge.

2. The method for improving solid-liquid separation performance of sludge by in-situ crystallization of water according to claim 1, wherein the low-temperature condition comprises 1° C. to 10° C.

3. The method for improving solid-liquid separation performance of sludge by in-situ crystallization of water according to claim 1, wherein intermittently introducing the carbon dioxide comprises:
after the high-pressure carbon dioxide is introduced, sealing the vessel, continuing to stir until the partial pressure of the carbon dioxide drops to an equilibrium pressure, introducing the high-pressure carbon dioxide; and
circulating in such a way until the partial pressure of the carbon dioxide no longer drops after the vessel is sealed.

4. The method for improving solid-liquid separation performance of sludge by in-situ crystallization of water according to claim 3, wherein the pressure of the introduced carbon dioxide is 1,500 kPa to 5,000 kPa.

5. The method for improving solid-liquid separation performance of sludge by in-situ crystallization of water according to claim 4, wherein a phase equilibrium pressure of the carbon dioxide is 1,414 kPa to 4,292 kPa.

6. A reaction system capable of achieving the method according to claim 1, comprising a reaction kettle body for accommodating sludge, a refrigeration jacket arranged outside the reaction kettle body, a gas compressor and a carbon dioxide storage tank which are in communicate with the reaction kettle body in sequence, and a stirring assembly arranged on the reaction kettle body.

7. The reaction system according to claim 6, wherein the system further comprises a cooler and a refrigerant circulating pipe which are in circular communication; the refrigeration jacket is internally provided a refrigerating medium, and the refrigerant circulating pipe is immersed in the refrigerating medium.

8. The reaction system according to claim 6, wherein the refrigeration jacket is further provided with a temperature detection sensor.

9. The reaction system according to claim 6, wherein the reaction kettle body is further provided with a carbon dioxide pressure sensor.

10. The reaction system according to claim 6, wherein a bottom of the reaction kettle body is provided with a sludge discharge pipe.

11. The reaction system according to claim 6, wherein the low-temperature condition comprises 1° C. to 10° C.

12. The reaction system according to claim 6, wherein intermittently introducing the carbon dioxide comprises:
after the high-pressure carbon dioxide is introduced, sealing the vessel,
continuing to stir until the partial pressure of the carbon dioxide drops to an equilibrium pressure,
introducing the high-pressure carbon dioxide; and
circulating in such a way until the partial pressure of the carbon dioxide no longer drops after the vessel is sealed.

13. The reaction system according to claim 12, wherein the pressure of the introduced carbon dioxide is 1,500 kPa to 5,000 kPa.

14. The reaction system according to claim 13, wherein a phase equilibrium pressure of the carbon dioxide is 1,414 kPa to 4,292 kPa.

15. The reaction system according to claim 11, wherein the system further comprises a cooler and a refrigerant circulating pipe which are in circular communication; the refrigeration jacket is internally provided a refrigerating medium, and the refrigerant circulating pipe is immersed in the refrigerating medium.

16. The reaction system according to claim 12, wherein the system further comprises a cooler and a refrigerant circulating pipe which are in circular communication; the refrigeration jacket is internally provided a refrigerating medium, and the refrigerant circulating pipe is immersed in the refrigerating medium.

17. The reaction system according to claim 13, wherein the system further comprises a cooler and a refrigerant circulating pipe which are in circular communication; the refrigeration jacket is internally provided a refrigerating medium, and the refrigerant circulating pipe is immersed in the refrigerating medium.

18. The reaction system according to claim 14, wherein the system further comprises a cooler and a refrigerant circulating pipe which are in circular communication; the refrigeration jacket is internally provided a refrigerating medium, and the refrigerant circulating pipe is immersed in the refrigerating medium.

19. The reaction system according to claim 11, wherein the refrigeration jacket is further provided with a temperature detection sensor.

20. The reaction system according to claim 12, wherein the refrigeration jacket is further provided with a temperature detection sensor.
